(19) United States
(12) Patent Application Publication
(10) Pub. No.: US 2025/0266195 A1
(43) Pub. Date: Aug. 21, 2025

(54) MAGENTIC MATERIAL AND MULTILAYER INDUCTOR CONTAINING THE SAME

(71) Applicant: Steward (Foshan) Magnetics Co., Ltd., Foshan City (CN)

(72) Inventors: Jacken Zhang, Foshan City (CN); Yeat Shing Chiang, Foshan City (CN); Wenshan Pang, Foshan (CN)

(21) Appl. No.: 19/197,243

(22) Filed: May 2, 2025

Related U.S. Application Data
(63) Continuation of application No. PCT/CN2023/128371, filed on Oct. 31, 2023.

(30) Foreign Application Priority Data
Nov. 2, 2022 (CN) 202211360830.6

(51) Int. Cl. H01F 1/34; H01F 27/28

(52) U.S. Cl. CPC H01F 1/344; H01F 27/2804; H01F 2027/2809

(57) ABSTRACT

The present disclosure relates to a magnetic material and a multilayer inductor including the same. The magnetic material is formed by sintering an oxide for forming a ferrite material and a doped oxide. The magnetic material has a crystal structure. The doped oxide is distributed on the grain boundary of the crystal structure in the form of a doped phase. The content of the doped oxide is 5 wt % or less based on the total weight of the magnetic material. According to the present disclosure, the magnetic material can improve the grain boundary resistance at a low sintering temperature and increase the impedance of the magnetic material.

### CROSS-REFERENCE TO RELATED APPLICATIONS

This application is a continuation-in-part of PCT International Patent Application No. PCT/CN2023/128371 filed Oct. 31, 2023 (published as WO2024/093990 on May 10, 2024), which, in turn, claims the benefit of and priority to Chinese Patent Application No. 202211360830.6 filed Nov. 2, 2022 (which published as CN 118039279 A on May 14, 2024). The entire contents of these applications are incorporated herein by reference.

### FIELD

The present disclosure relates to the field of electronic devices, and in particular, to a multilayer inductor structure for power applications. The multilayer inductor is usable for voltage and current conversion of power transmission, impedance matching of data transmission and processing, and filtering of electromagnetic interference.

### BACKGROUND

This section provides background information related to the present disclosure which is not necessarily prior art.

As one of the passive devices, inductors can be generally divided into: winding type inductors, which are manufactured by winding a coil on a ferrite core and forming electrodes at both ends thereof; and multilayer type inductors, which are manufactured by printing inner electrodes on a magnetic layer or a dielectric layer and then stacking the magnetic layer or the dielectric layer.

In recent years, due to the development of thick film printing technology and LTCC materials, passive components such as resistors, capacitors and inductors need to be further miniaturized. As the best SMT inductor solution for miniaturization and low cost in small circuit boards, multilayer inductors have gradually gained dominance compared to winding inductors.

Generally, a multilayer inductor includes a multilayer body formed of a plurality of magnetic sheets having an internal electrode of a coil pattern formed on one surface thereof.

As the body material or core material, ferrite materials are usually used, and as the electrode material, metals such as silver are usually used. When the inductor core is co-fired with a metal track such as silver to obtain an integral structure, the sintering temperature of the core is usually below 900° C., which is lower than the melting point of silver (about 963° C.). Therefore, additional components need to be added, which will reduce the core magnetic properties. In addition, high core resistance is required to insulate the silver conductive traces, which will also reduce the magnetic properties.

There are many technologies for improving such magnetic materials in the prior art. For example, CN112341179A proposes a high-frequency manganese-zinc ferrite material, which includes a main crystal phase and a doped crystal phase, wherein the doped crystal phase is uniformly doped in the grain boundary and the main crystal phase. CN107004478A proposes a magnetic material, which includes a magnetic phase and a grain boundary phase, wherein the grain boundary phase includes at least one metal and has a lower melting temperature than the magnetic phase. CN106486236A proposes a magnetic core material, which includes a crystalline phase and an insulating film, wherein the insulating film surrounds the crystalline phase.

But above technology has little effect on the improvement of the magnetic properties or magnetic flux density of the magnetic core material. Therefore, there is still a need in the art to develop a technology to improve the magnetic properties or magnetic flux density of the magnetic core material.

### DRAWINGS

The drawings described herein are for illustrative purposes only of selected embodiments and not all possible implementations, and are not intended to limit the scope according to the present disclosure.

FIG. 1 is a schematic cross-sectional view of a commonly used multilayer inductor structure.

FIG. 2 is a schematic diagram of the microstructure of a magnetic material according to the present disclosure.

FIG. 3 is a scanning electron microscope (SEM) image of the microstructure of the magnetic material obtained in Example 1 according to the present disclosure.

FIG. 4 is an electron probe microanalyzer (EPMA) imaging diagram of the magnetic material obtained in Example 1 according to the present disclosure.

FIG. 5 is an inductance-frequency curve obtained by electrical testing of the devices obtained in Example 1 and Comparative Examples 1 to 2 according to the present disclosure.

FIG. 6 is an impedance-frequency graph obtained by electrical testing of the devices obtained in Example 1 and Comparative Examples 1 to 2 according to the present disclosure.

FIG. 7 is a current-inductance curve diagram obtained by conducting electrical tests on the devices prepared in Example 1 according to the present disclosure and Comparative Examples 1 to 2.

### DETAILED DESCRIPTION

Example embodiments will now be described more fully with reference to the accompanying drawings.

Exemplary embodiments according to the present disclosure are directed to providing a magnetic material for a magnetic core of a multilayer inductor, in which grain boundary resistance at a low sintering temperature can be improved and the proportion of non-magnetic material can be minimized by adding a specific inorganic additive to the magnetic material to assist the formation of magnetic powder.

The inventors hereof have discovered that the sintering of ferrite materials can be promoted by using dissolution-promoting elements such as silicon (Si), bismuth (Bi), and calcium (Ca). Among them, silicon can promote the low-temperature sintering of ferrite and form high-resistance precipitates at the grain boundaries. Bismuth can form a low-melting-point phase to promote the growth of ferrite particles. At the same time, by lowering the sintering temperature, the sintered particle size is reduced, the grain boundary resistance is increased, the iron (Fe) ratio is reduced, and the generation of Fe2+ in the ferrite is reduced. Calcium can also increase the grain boundary resistance and play a dissolution-promoting role together with the silicon element to achieve the purpose of lowering the sintering temperature; and, by increasing the high-resistivity nickel (Ni) content, the overall resistance can be improved, thereby completing the present disclosure.

Another aspect according to the present disclosure relates to a multilayer inductor that can achieve excellent magnetic characteristics or magnetic flux density by improving its core material. According to an exemplary embodiment according to the present disclosure, there is provided a magnetic material for a magnetic core of a multilayer inductor, which is formed by sintering an oxide for forming a ferrite material and a doped oxide, characterized in that the magnetic material has a crystal structure, and the doped oxide is distributed on the grain boundaries of the crystal structure in the form of a doped phase, and the content of the doped oxide is less than 5 weight % based on the total weight of the magnetic material.

In one embodiment, the doped oxide comprises silicon dioxide, bismuth oxide, optionally calcium oxide, or a combination thereof.

In one embodiment, the magnetic material comprises a ferrite material forming grains in a crystal structure, and the main material is Fe2O3 (iron oxide).

In addition, in a specific embodiment, the ferrite material further comprises at least one selected from manganese oxide (Mn3O4), nickel oxide (NiO), copper oxide (CuO), and zinc oxide (ZnO) as an additive.

In a specific embodiment, the ferrite material is nickel copper zinc (NiCuZn) ferrite, and the chemical formula is NiCuZnFe2O4.

In a specific embodiment, based on the total weight of the oxides used to form the ferrite material, the content of Fe2O3 can be 62 to 65 weight %; the content of NiO can be 10 to 13 weight %; the content of ZnO can be 19 to 22 weight %; the content of CuO can be 2 to 5 weight %; the content of Mn3O4 can be 0 to 1 weight %, preferably 0.1 to 1 weight %.

In one embodiment, based on the total weight of the magnetic material, based on the total weight of the oxides used to form the ferrite material, the preferred content of the doping oxide is: silicon dioxide (SiO2): 0.01 to 0.15 wt %; bismuth oxide (Bi2O3): 0.1 to 3 wt %; calcium oxide (CaO): 0 to 1.5 wt %.

In one embodiment, based on the total weight of the magnetic material, based on the total weight of the oxides used to form the ferrite material, the preferred content of the doping oxide is: SiO2: 0.01 to 0.15 wt %; Bi2O3: 1 to 3 wt %; CaO: 0 to 1.5 wt %.

According to another aspect according to the present disclosure, there is provided a multilayer inductor including a plurality of magnetic layers and metal electrode tracks formed on the magnetic layers, the magnetic layers including the magnetic material for the magnetic core of the multilayer inductor according to the present disclosure.

In one embodiment, the metal electrode includes silver (Ag), platinum (Pt), palladium (Pd), copper (Cu), gold (Au), nickel (Ni), or alloys thereof, or composites thereof.

According to another aspect according to the present disclosure, there is provided a method for preparing the magnetic material according to the present disclosure, the method comprising the following steps:
(a) mixing and grinding oxides for forming a ferrite material with water and optionally a dispersant, and granulating and drying the resulting product;
(b) adding the granular powder obtained in step (a) into a pre-calcining furnace for pre-calcining to remove CO32+ in the granules and perform a preliminary pre-reaction;
(c) the pre-calcined product obtained in step (b) is crushed and mixed with a doping oxide, water and an optional dispersant are added, and the mixture is fully ground and dried to obtain a magnetic material powder.

In one embodiment, the method further comprises step (d) The magnetic material powder obtained in step (c) is prepared into a laminated inductor and sintered.

In one embodiment, the oxide used to form the ferrite material includes Fe2O3 and one or more of NiO, Mn3O4, CuO and ZnO as additives.

In one embodiment, the step (a) comprises adding Fe2O3 and one or more of NiO, Mn3O4, CuO and ZnO powders as additives into a ball mill, stirring and mixing them thoroughly, and then spray drying them by a spray granulator.

In one embodiment, the steps (a) and (c) are performed by a ball mill.

In one embodiment, the dispersant in step (a) comprises an alcohol dispersant, such as PEG400.

In one embodiment, the step (c) is performed by spray drying using a spray granulator.

In one embodiment, the step (d) is performed by tape casting.

Exemplary embodiments according to the present disclosure may provide one or more beneficial effects. By adding specific doping oxide particles to the grain boundaries of the crystal structure of the magnetic material, the grain boundary resistance at a low sintering temperature can be improved and the proportion of non-magnetic material can be minimized.

By doping oxide particles, the sintering temperature of ferrite materials can be reduced, for example, to below 890° C., and a higher surface resistance can be obtained. After the surface resistance is increased, the equivalent resistance at high frequencies can be increased, and the impedance at high frequencies can also be increased; at the same time, the increased surface resistance also provides higher reliability for circuit design, so that the circuit layout can be closer, and it will not cause a short circuit of the entire product when the power is turned on.

By including the magnetic material according to the present disclosure, the multilayer inductor according to the present disclosure can achieve excellent magnetic characteristics or magnetic flux density.

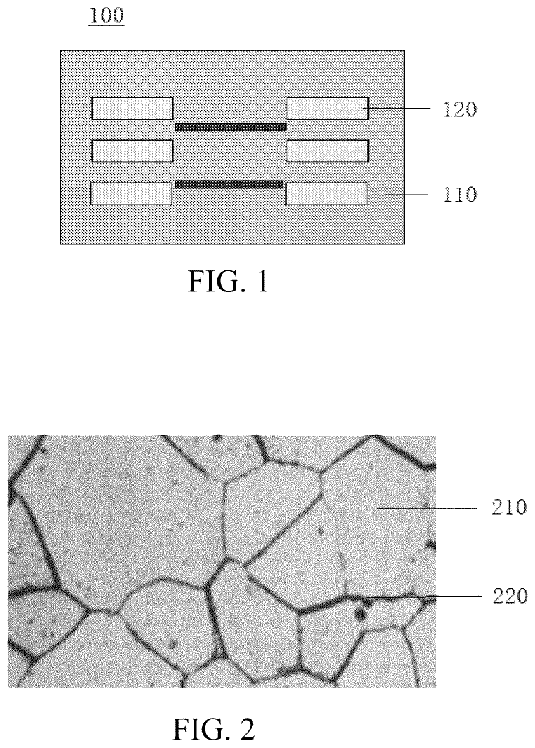

With reference to the figures, FIG. 1 shows a schematic cross-sectional view of a multilayer inductor structure commonly used in the art. The multilayer inductor 100 includes a plurality of magnetic layers 110 and a plurality of metal electrode tracks 120 formed on the plurality of magnetic layers.

The material of the magnetic layer can be a magnetic material, that is, a magnetic ceramic material, that is, a ferrite material. For example, as an example, the oxide powder used to form the ferrite can include iron oxide powder, and zinc oxide powder, copper oxide powder, nickel oxide powder, etc. as additives.

Generally, as known in the art, commonly used ferrite materials can be divided into NiZn ferrite materials and MnZn ferrites. For example, a Cu additive can be further included in the NiZn ferrite material to change the formation mechanism of the NiZn ferrite phase and reduce the formation temperature of the spinel phase.

Therefore, in one embodiment according to the present disclosure, the ferrite material contains at least one selected from Mn3O4, NiO, CuO, and ZnO as an additive in addition to Fe2O3. Preferably, the ferrite material is NiCuZn ferrite with a chemical formula of NiCuZnFe2O4.

In a specific embodiment, when the ferrite material is NiCuZn ferrite, based on the total weight of the oxides used to form the ferrite material, the content of Fe2O3 can be 62 to 65 weight %; the content of NiO can be 10 to 13 weight %; the content of ZnO can be 19 to 22 weight %; and the content of CuO can be 2 to 5 weight %.

In addition, a small amount of manganese (Mn) additives may be added to the NiCuZn ferrite to improve Bs and thermal conductivity (Tc). Thus, in a specific embodiment, based on the total weight of the oxides used to form the ferrite material, the content of Fe2O3 may be 62 to 65% by weight; the content of NiO may be 10 to 13% by weight; the content of ZnO may be 19 to 22% by weight; the content of CuO may be 2 to 5% by weight; and the content of Mn3O4 may be 0 to 1% by weight, preferably 0.1 to 1% by weight.

In addition, the metal electrode includes silver (Ag), platinum (Pt), palladium (Pd), copper (Cu), gold (Au), nickel (Ni), or alloys thereof, or composites thereof.

In exemplary embodiments according to the present disclosure, the magnetic material of the magnetic layer is formed by sintering oxides used to form ferrite materials and doped oxides, characterized in that the magnetic material has a crystal structure, and the doped oxides are distributed on the grain boundaries of the crystal structure in the form of doped phases, and the content of the doped oxides is less than 5 weight % based on the total weight of the magnetic material.

In one embodiment, the doped oxide comprises silicon dioxide, bismuth oxide, optionally calcium oxide or a combination thereof. Preferably, the doped oxide comprises silicon dioxide and bismuth oxide.

FIG. 2 shows a schematic diagram of the microstructure of the magnetic material according to the present disclosure. The magnetic material has a plurality of magnetic grains or crystal phases 210. At the grain boundaries between the grains or crystal phases 210, the above-mentioned doped oxide doped phase 220 is formed. The grains or crystal phases 210 are formed by the above-mentioned ferrite material, such as NiCuZn ferrite crystal phase; and the doped phase 220 is formed by the above-mentioned doped oxide.

Due to the formation of the doped phase 220 at the grain boundary, under the action of elements such as Si, Bi and Ca, when the temperature rises, the grain boundary elements can affect the formation of ferrite and reduce the sintering temperature, and when the temperature drops, they can precipitate in the grain boundary to form a grain boundary phase with high resistivity.

Specifically, based on the total weight of the oxides used to form the ferrite material, the preferred addition amount or content of the doping oxide is: SiO2: 0.01 to 0.15 wt %; Bi2O3: 0.1 to 3 wt %; CaO: 0 to 1.5 wt %. Preferably, the content of SiO2 can be 0.01 to 0.12 wt %, 0.02 to 0.10 wt %, 0.03 to 0.08 wt %; the content of Bi2O3 can be 1 to 2.5 wt %; 1.5 to 3 wt %; 1 to 2 wt %; the content of CaO can be 0 to 1 wt %, 0.5 to 1.5 wt %.

When the content of the doped oxide exceeds the upper limit defined above, it cannot bring about further gain effect, but instead deteriorates the performance of the obtained magnetic material, such as inductance and impedance at high frequencies.

The effects of doping oxides are as follows. For example, adding an appropriate amount of Bi2O3 to NiZn ferrite can accelerate the ion diffusion rate at a lower sintering temperature and promote grain growth. In addition, at the microstructural level, the material modification is achieved by changing the morphology of magnetic grains and introducing new grain boundary phases through the fluxing effect of Bi2O3.

SiO2 can react with iron oxide to generate iron silicate and produce oxygen during the sintering of ferrite. The melting point of iron silicate is only 1150° C., so it can be used as a flux. At the same time, adding SiO2 and Bi2O3 in the form of SiO2·Bi2O3 can effectively reduce the sintering temperature of NiZn ferrite to 890° C., and can also broaden the frequency band of ferrite and increase the cutoff frequency.

At the same time, SiO2 and CaO can also form SiO2·CaO molten glass, which can also reduce the sintering temperature. During the sintering process, the above SiO2·Bi2O3 and SiO2·CaO precipitate in the grain boundaries during the cooling process, thereby forming high-resistance compounds in the grain boundaries. Therefore, adding SiO2, Bi2O3 and optional CaO can both reduce the sintering temperature and increase the grain boundary resistance.

In another aspect, the present disclosure provides a method for preparing the magnetic material, comprising the following steps:
(a) mixing and grinding oxides for forming a ferrite material with water and optionally a dispersant, and granulating and drying the resulting product;
(b) adding the granular powder obtained in step (a) into a pre-calcining furnace for pre-calcining to remove CO32+ in the granules and perform a preliminary pre-reaction;
(c) crushing the pre-sintered product in step (b), mixing it with a doping oxide, adding water and an optional dispersant, and grinding and drying it sufficiently to obtain a magnetic material powder; and, optionally
(d) The magnetic material powder obtained in step (c) is prepared into a laminated inductor, and then sintering is performed.

In the art, sintering is usually performed at a high temperature of 930° C. to 950° C. However, in the present disclosure, due to the above-mentioned effect of the doped oxide, the sintering temperature can be reduced to, for example, below 890° C., thereby the inductor core can be co-fired with a metal track such as silver to obtain the multilayer inductor according to the present disclosure.

For example, in one embodiment, the method is performed as follows:
(a) Fe2O3, NiO, CuO, ZnO, optional Mn3O4 and water are mixed, a dispersant (PEG400) is added, the mixture is stirred and mixed thoroughly, and then spray-dried by a spray granulator;
(b) adding the spray-dried granular powder into a pre-calcining furnace for pre-calcining, for example, at 700° C. for 2 hours to remove CO32+ in the particles and to perform a preliminary pre-reaction;
(c) adding the pre-sintered powder into a ball mill, adding doping oxides SiO2, Bi2O3, optional CaO or CaCO3, optional dispersant and water, then grinding thoroughly and spray drying by a spray granulator;
(d) The obtained powder is formed into a cast sheet by tape casting, and then prepared into a monolithic high-impedance magnetic bead by lamination; subsequently, it is sintered in an air atmosphere, for example, sintered at 890° C. for 1 to 3 hours, preferably sintered for 2 hours.

Step (a) is carried out by ball milling mixing under the conditions of: mixing for 4 to 8 hours at room temperature, and its main function is to mix the powder.

The spray drying conditions in steps (a) and (c) are as follows: the air outlet temperature is controlled to be about 100° C.

Alternatively, pulverization may be performed by a conventional ball milling method, with a target particle size of D50=1.0 to 1.3 μm.

Here, the amount range of Fe2O3 and additives such as NiO, MnO, CuO, ZnO powder, etc. is as described above for magnetic materials. In step (c), CaO can be replaced by CaCO3, and CaCO3 can be converted into CaO during the sintering process to provide a Ca source.

In one embodiment, the dispersant in step (a) includes, for example, PEG400, which functions to achieve uniform mixing of the mixed materials.

In steps (a) and (c), the amount of water used for mixing is not particularly limited as long as the amount can enable the mixture to be ground. For example, in a specific embodiment, the amount of water can be 30% by weight based on the total weight of the obtained mixture, that is, the solid content in the mixture can be 70% by weight.

In addition, in step (d), the temperature of the tape casting is about 70° C. to 90° C., for example, 80° C.

In addition, the present disclosure also provides a multilayer inductor, which includes a plurality of magnetic layers and metal electrode tracks formed on the magnetic layers, wherein the magnetic layers include the above-mentioned magnetic material for the magnetic core of the multilayer inductor.

Because the magnetic material according to the present disclosure as described above has a relatively high surface resistance, the multilayer inductor according to the present disclosure can increase the equivalent resistance at high frequencies, and can also increase the impedance at high frequencies. At the same time, the increased surface resistance also provides higher reliability for circuit design, so that the multilayer inductor according to the present disclosure can be applied to multiple fields.

### EXAMPLE

Hereinafter, the present disclosure will be explained in detail with reference to examples. But the embodiments according to the present disclosure may be modified into various other types, and the scope according to the present disclosure should not be limited to the embodiments described below. The embodiments according to the present disclosure are provided to fully explain the present disclosure to people with ordinary knowledge in the art.

Unless otherwise specified, the percentages in the examples are based on mass. In addition, the raw materials and equipment information involved in the examples are as follows:
Fe2O3: analytically pure, Fe2O3≥99.5%
NiO: analytically pure, NiO≥99.7%
Mn3O4: analytically pure, Mn3O4≥99.5%
CuO: analytical grade, CuO≥99.7%
ZnO: analytically pure, ZnO≥ 99.7%
SiO2: analytically pure, SiO2≥99.9%, nano-grade SiO2
Bi2O3: analytically pure, Bi2O3≥99.7%,
CaCO3: analytical grade, CaCO3≥99.7%
Dispersant: PEG400 polyvinyl alcohol
Water: Deionized water, conductivity less than 0.1 μS/cm
Ball mill: planetary ball mill, conventional experimental machine
Spray granulator: small spray granulator, conventional experimental machine
Scanning electron microscope: Zeiss EVO MA10
Electron probe (EPMA) test equipment: JEOL JXA-8230

### Example 1

Based on the ferrite material to be prepared, 66 wt % (147.84 g) of Fe2O3, 9 wt % (20.16 g) of NiO, 1 wt % (2.24 g) of Mn3O4, 4 wt % (8.96 g) of CuO, and 20 wt % (44.8 g) of ZnO powder were added to the material tank of the ball mill, and then 400 g of water and 1 g of dispersant (PEG400) were added, followed by ball milling mixing (4 h, room temperature), and spray drying (2 h, 100° C.) by a spray granulator. Then, the spray-dried granular powder was added to the pre-calcining furnace for pre-calcining.

Next, based on the total weight of the pre-fired ferrite material, 0.08 wt % (0.18 g) SiO2 and 1 wt % (2.24 g) Bi2O3, 1 wt % (0.67 g) CaCO3 of doping oxides were added, and ball milling (time 10 h, room temperature) and spray drying (2 hours, room temperature) were carried out to form the required magnetic material powder.

Then, the obtained magnetic material powder is prepared into a laminated inductor by tape casting, and co-sintered with the Ag track (890° C., 2 hours) to obtain the multilayer inductor of Example 1, which has the basic structure shown in FIG. 1.

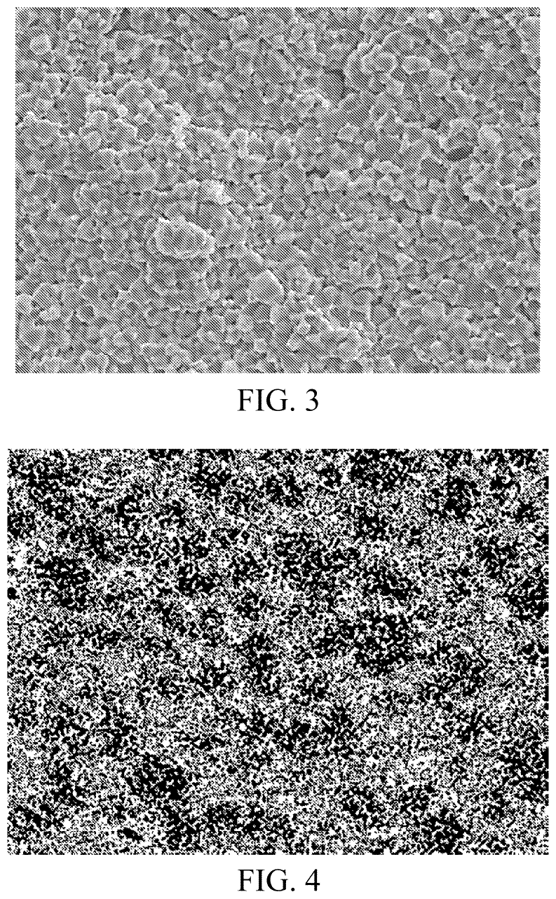

The magnetic core of the obtained multilayer inductor is subjected to electronic scanning, and its SEM image is shown in FIG. 3. It can be seen that the magnetic core of the obtained multilayer inductor has a uniform crystal phase structure.

The element distribution of the magnetic core was analyzed using EPMA technology, and the image shown in FIG. 4 was obtained. It can be seen that the doping elements (Ca, Si and Bi) are distributed as doping phases at the grain boundaries of the crystal phase structure, as shown in the white part of FIG. 4.

### Comparative Example 1

Based on the ferrite material to be prepared, 66 wt % (147.84 g) of Fe2O3, 9 wt % (20.16 g) of NiO, 1 wt % (2.24 g) of Mn3O4, 4 wt % (8.96 g) of CuO, and 20 wt % (44.8 g) of ZnO powder were added to the material tank of the ball mill, and then 400 g of water and 1 g of dispersant (PEG400) were added, and then ball milling was performed (4 h, room temperature), and spray-dried by a spray granulator (2 h, 100° C.). Then, the spray-dried granular powder was added to the pre-calcining furnace for pre-calcining.

Next, ball milling (10 hours, room temperature) and spray drying (2 hours, room temperature) are performed to form the desired magnetic material powder.

Then, the obtained magnetic material powder was prepared into a multilayer inductor by tape casting, and co-sintered with the Ag track (890° C., 2 hours) to obtain the multilayer inductor of Comparative Example 1.

Comparative Example 2

Based on the ferrite material to be prepared, 66 wt % (147.84 g) of Fe2O3, 9 wt % (20.16 g) of NiO, 1 wt % (2.24 g) of Mn3O4, 4 wt % (8.96 g) of CuO, and 20 wt % (44.8 g) of ZnO powder were added to the material tank of the ball mill, and then 400 g of water and 1 g of dispersant (PEG400) were added, followed by ball milling mixing (4 h, room temperature), and spray drying (2 h, 100° C.) by a spray granulator. Then, the spray-dried granular powder was added to the pre-calcining furnace for pre-calcining.

Next, based on the total weight of the pre-fired ferrite material, 0.2 wt % (0.4 g) SiO2 and 1.5 wt % (3 g) Bi2O3, 2 wt % (4 g) CaCO3 as doping oxides were added, and ball milling (time 10 h, room temperature) and spray drying (2 hours, room temperature) were performed to form the required magnetic material powder.

Then, the obtained magnetic material powder is prepared into a multilayer inductor by tape casting, and co-sintered with the Ag track (890° C., 2 hours) to obtain the multilayer inductor of Example 2.

### Test Example

In this test example, the impedance tester 4396 is used to test the impedance, and the inductance test is tested using the Agilent 4991 network analyzer.

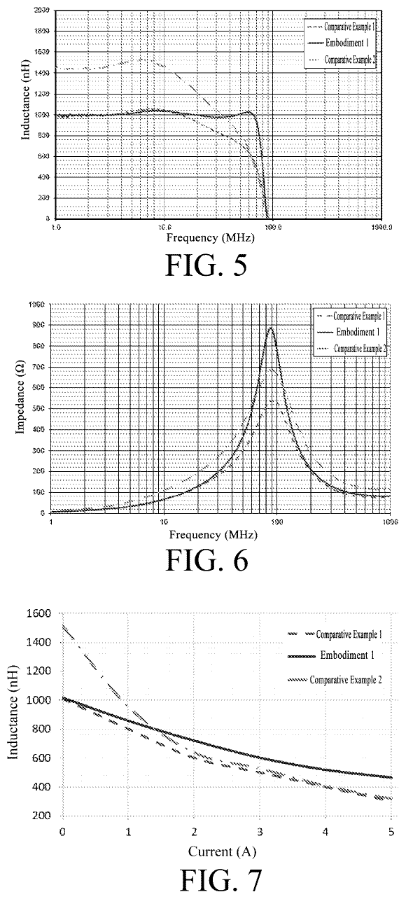

The multilayer inductors obtained in Example 1 and Comparative Examples 1 to 2 were tested, and the results are shown in FIGS. 5 to 7.

By determining the additives to minimize the non-magnetic components in the core, it can be seen from FIGS. 5 to 7 that:
1. The function of Si, Ca and Bi to promote low-temperature sintering improves the density of the product itself, that is, from 4.98 g/cm3 to 5.2 g/cm3, thereby increasing Bs, that is, the maximum magnetic flux density is increased from 0.3 Tesla to 0.35 Tesla, thereby improving the product, DC superposition characteristics. This result can be seen from the current-inductance diagram (FIG. 7). When the current is greater than 1 A, the inductance decreases more slowly, indicating that the superposition characteristics are improved;
2. At the same time, the high grain boundary resistance formed by SiO2·CaO and SiO2·Bi2O3 after cooling can improve the inductance at high frequencies, so the inductance at high frequencies can also be improved;
3. After lowering the sintering temperature, the crystal grain size decreases. This method is also conducive to increasing high-frequency inductance, thereby increasing the impedance.

In addition, it can be confirmed that in the absence of the doping elements Si, Bi or Ca according to the present disclosure, the sintering temperature is significantly increased because the doping phase is not formed at the grain boundary. Referring to FIGS. 5 and 6, it can be seen that the impedance of the inductor material obtained in Comparative Example 1 is the lowest and the inductance is also the lowest, which is significantly inferior to Example 1 according to the present disclosure.

Moreover, by comparing Example 1 and Comparative Example 2, it can be seen that if the doping elements according to the present disclosure are added in excess, it can be seen from the inductance-frequency curve (FIG. 5) that although the inductance can be improved, the inductance at high frequency (close to 100 MHz) is not improved (Comparative Example 2). On the contrary, the inductance of Example 1 maintains a high value even at high frequency. In addition, it can be seen from the impedance-frequency curve (FIG. 6) that although the impedance of Comparative Example 2 is improved compared with Comparative Example 1, the impedance increase value is far less than that of Example 1; in addition, it can be seen from the current-inductance curve (FIG. 7) that the improved inductance does not improve the DC-Bias characteristics very well. This also proves that the doping elements according to the present disclosure, such as Si, Bi, Ca, etc., should be kept within the range defined above.

Example embodiments are provided so that this disclosure will be thorough, and will fully convey the scope to those who are skilled in the art. Numerous specific details are set forth such as examples of specific components, electronic devices, and methods, to provide a thorough understanding of embodiments according to the present disclosure. It will be apparent to those skilled in the art that specific details need not be employed, that example embodiments may be embodied in many different forms, and that neither should be construed to limit the scope of the disclosure. In some example embodiments, well-known processes, well-known electronic device structures, and well-known technologies are not described in detail. In addition, advantages and improvements that may be achieved with one or more exemplary embodiments according to the present disclosure are provided for purpose of illustration only and do not limit the scope according to the present disclosure, as exemplary embodiments disclosed herein may provide all or none of the above mentioned advantages and improvements and still fall within the scope according to the present disclosure.

Specific dimensions, specific materials, and/or specific shapes disclosed herein are example in nature and do not limit the scope according to the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or, for example, the term “about” as used herein when modifying a quantity of an ingredient or reactant of the disclosure or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the electronic device in use or operation in addition to the orientation depicted in the figures. For example, if the electronic device in the figures is turned over, elements described as “below” or “beneath” other elements or features would then be oriented “above” the other elements or features. Thus, the example term “below” can encompass both an orientation of above and below. The electronic device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-20. (canceled)

21. A magnetic material for a magnetic core of a multilayer inductor, the magnetic material being formed by sintering an oxide used for forming a ferrite material and a doping oxide, and being characterized in that the magnetic material has a crystal structure, the doping oxide is distributed on grain boundaries of the crystal structure in a doped phase, and the content of the doping oxide is 5 wt % or less based on the total weight of the magnetic material.

22. The magnetic material of claim 21, wherein the doping oxide comprises silicon dioxide, bismuth oxide, or a combination thereof.

23. The magnetic material of claim 22, wherein the doping oxide further comprises calcium oxide.

24. The magnetic material of claim 21, wherein the ferrite material comprises Fe₂O₃ and at least one selected from Mn₃O₄, NiO, CuO, and ZnO as an additive.

25. The magnetic material of claim 21, wherein based on the total weight of the oxide used for forming the ferrite material, the ferrite material:
Fe₂O₃: 62 to 65% by weight;
NiO: 10 to 13% by weight;
ZnO: 19 to 22% by weight;
CuO: 2 to 5% by weight; and
Mn₃O₄: 0 to 1 wt %.

26. The magnetic material of claim 21, wherein based on the total weight of the oxide used for forming the ferrite material, the content of the doping oxide is:
SiO: 0.01 to 0.15 wt %;
Bi₂O₃: 0.1 to 3 wt. %; and
CaO: 0 to 1.5 wt %.

27. The magnetic material of claim 21, wherein:
based on the total weight of the oxide used for forming the ferrite material, the ferrite material comprises:
Fe₂O₃: 62 to 65% by weight;
NiO: 10 to 13% by weight;
ZnO: 19 to 22% by weight;
CuO: 2 to 5% by weight; and
Mn₃O₄: 0 to 1 wt %;
based on the total weight of the oxide used for forming the ferrite material, the content of the doping oxide is:
SiO: 0.01 to 0.15 wt %;
Bi₂O₃: 0.1 to 3 wt. %; and
CaO: 0 to 1.5 wt %.

28. A method for preparing the magnetic material of claim 21, the method comprising the following steps:
(a) mixing an oxide for forming a ferrite material with water and then grinding and granulating and drying a resulting product;
(b) adding a granular powder obtained in step (a) into a pre-sintering furnace for pre-sintering to remove CO₃²⁺ in the granules, and carrying out a preliminary pre-reaction; and
(c) pulverizing a product pre-sintered in step (b) and mixing the product with a doping oxide, adding water, and fully grinding and drying, thereby obtaining a magnetic material powder.

29. The method of claim 28, further comprising preparing a laminated inductor body from the magnetic material powder obtained in step (c) and then sintering the laminated inductor body.

30. The method of claim 28, wherein:
step (a) includes mixing the oxide for forming the ferrite material with water and a dispersant; and
step (c) includes mixing the product obtained in step (b) with the doping oxide, water, and a dispersant.

31. The method of claim 30, wherein the dispersant in steps (a) and (c) includes an alcohol dispersant.

32. The method of claim 28, wherein:
based on the total weight of the oxide used for forming the ferrite material, the ferrite material comprises:
Fe₂O₃: 62 to 65% by weight;
NiO: 10 to 13% by weight;
ZnO: 19 to 22% by weight;
CuO: 2 to 5% by weight; and
Mn₃O₄: 0 to 1 wt %; and
based on the total weight of the oxide used for forming the ferrite material, the content of the doping oxide is:
SiO: 0.01 to 0.15 wt %;
Bi₂O₃: 0.1 to 3 wt. %; and
CaO: 0 to 1.5 wt %.

33. A multilayer inductor comprising a plurality of magnetic layers and metal electrode tracks formed on the magnetic layers, the magnetic layers comprising a magnetic material comprising a ferrite material including a sintered oxide and a doping oxide, wherein:
the magnetic material has a crystal structure;
the doping oxide is distributed on grain boundaries of the crystal structure in a doped phase; and
the content of the doping oxide is 5 weight % or less based on the total weight of the magnetic material.

34. The multilayer inductor of claim 33, wherein the doping oxide comprises silicon dioxide, bismuth oxide, or a combination thereof.

35. The multilayer inductor of claim 34, wherein the doping oxide further comprises calcium oxide.

36. The multilayer inductor of claim 33, wherein the ferrite material comprises Fe₂O₃ and at least one selected from Mn₃O₄, NiO, CuO, and ZnO as an additive.

37. The multilayer inductor of claim 33, wherein based on the total weight of the oxide used for forming the ferrite material, the ferrite material comprises:
Fe₂O₃: 62 to 65% by weight;
NiO: 10 to 13% by weight;
ZnO: 19 to 22% by weight;
CuO: 2 to 5% by weight; and
Mn₃O₄: 0 to 1 wt %.

38. The multilayer inductor of claim 33, wherein based on the total weight of the oxide used for forming the ferrite material, the content of the doping oxide is:
SiO: 0.01 to 0.15 wt %;
Bi₂O₃: 0.1 to 3 wt. %; and
CaO: 0 to 1.5 wt %.

39. The multilayer inductor of claim 33, wherein the metal electrode tracks comprise silver (Ag), platinum (Pt), palladium (Pd), copper (Cu), gold (Au), nickel (Ni), or an alloy thereof, or a composite thereof.

40. The multilayer inductor of claim 33, wherein:
based on the total weight of the oxide used for forming the ferrite material, the ferrite material comprises:
Fe₂O₃: 62 to 65% by weight;
NiO: 10 to 13% by weight;
ZnO: 19 to 22% by weight;
CuO: 2 to 5% by weight, and
Mn₃O₄: 0 to 1 wt %; and
based on the total weight of the oxide used for forming the ferrite material, the content of the doping oxide is:
SiO: 0.01 to 0.15 wt %;
Bi₂O₃: 0.1 to 3 wt. %; and
CaO: 0 to 1.5 wt %.
